(19) United States
(12) Patent Application Publication
(10) Pub. No.: US 2008/0035762 A1
(43) Pub. Date: Feb. 14, 2008

(54) Fuel Injector

(75) Inventor: Ferdinand Reiter, Markgroeningen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/662,621

(22) PCT Filed: Sep. 7, 2005
(86) PCT No.: PCT/EP05/54408

§ 371 Date: Aug. 7, 2007

(30) Foreign Application Priority Data
Sep. 29, 2004 (DE) 10 2004 047 179.7

(51) Int. Cl. F02M 51/06

(52) U.S. Cl. 239/585.1

(57) ABSTRACT

A fuel injector includes a solenoid coil, which cooperates with an armature acted upon by a restoring spring, the armature forming an axially displaceable valve part together with a valve needle. A valve-closure member, which forms a sealing seat together with a valve-seat body, is provided on the valve needle. A sealing of the valve sleeve is provided by a rubber disk affixed underneath the solenoid coil, which solenoid coil, which is axially prestressed, is pressed onto the rubber disk.

### BACKGROUND OF THE INVENTION

1. FIELD OF THE INVENTION

The present invention relates to a fuel injector.

2. DESCRIPTION OF RELATED ART

Published German patent document DE 40 03 227 describes a fuel injector which includes a core surrounded by a solenoid coil, an armature by which a valve-closure member cooperating with a fixed valve seat is actuable with the aid of a connecting tube welded to the armature; a tubular metal intermediate part which, by welding, is sealingly connected to an end of the core facing the armature via its one end, and to a tubular connecting part via its other end; and at least one bracket-type conducting element, which overlaps the solenoid coil and, by welding, is connected to the connecting part by its end facing the valve-closure member, and to the core via its other end. In each case, the welding of two overlapping components of the fuel injector is implemented in a region having a reduced cross section of one of the two components to be welded to one another.

A particular disadvantage of the fuel injector described in the aforementioned German patent document is that the production of the connections between the individual components of the fuel injector is complicated and thus time- and cost-intensive. Furthermore, the welded points are loaded thermally and thus lose some of their strength and flexural stiffness, which may lead to considerable resonances due to the different thicknesses of housing parts as well as to related noise development during operation of the fuel injector. In addition, a support ring, which is injection-molded underneath the seal on the side of the intake manifold, has the effect that contact points between the housing and valve sleeve are not reliably sealed, which may lead to problems due to poor sealing, especially in turbo-operation of the engine.

### BRIEF SUMMARY OF THE INVENTION

The fuel injector according to the present invention has the advantage of allowing reliable axial sealing between the housing and the valve sleeve by a fuel-resistant elastomer. This seal is a disk, e.g., made of rubber, which has the advantage that the utilized sealing element is simple and cost-effective. Another advantage is that the rubber disk requires only little space within the valve, which is reduced even further by compression of the rubber disk after installation.

During installation of the fuel injector, the axial force may be advantageously transmitted from the top to the rubber disk via the solenoid coil, by way of a projection provided on the end face of the coil brace, so that the rubber disk is pressed against the solenoid coil and the flange of the valve housing with sufficient force, thereby further improving the sealing.

The height and form of the projection are configured such that the coil is always pressed onto the rubber disk when the top is installed in its final position. This reliable sealing has the advantage that it is independent of the tolerances of the individual components; compensation of the tolerances is accomplished by selective deformation of the projection, and the coil is axially prestressed in a play-free manner.

Furthermore, the axial prestressing by the projection provided on the end face facing the top ensures that the hydraulic pressure of the elastic mass will not cause any additional axial displacement of the coil during injection-molding of the plug connector, which might damage the soldering of coil and plug clip.

It is advantageous that an inner radius of the disk is smaller than a radius of a valve sleeve. Moreover, it is advantageous that the inner radius of the disk is dimensioned such that sealing of the valve sleeve occurs.

### BRIEF DESCRIPTION OF THE SEVERAL VIEWS OF THE DRAWING

FIG. 1 shows a schematic cross-sectional view of an exemplary embodiment of a fuel injector according to the present invention.

FIG. 2 shows a schematic cross-sectional view of a portion of the fuel injector configured according to the present invention.

FIG. 3 shows a schematic cross-sectional view of a portion of the fuel injector configured according to the present invention, according to a second exemplary embodiment.

FIG. 4 shows a schematic cross-sectional view of a portion of the fuel injector configured according to the present invention, according to a third exemplary embodiment.

### DETAILED DESCRIPTION OF THE INVENTION

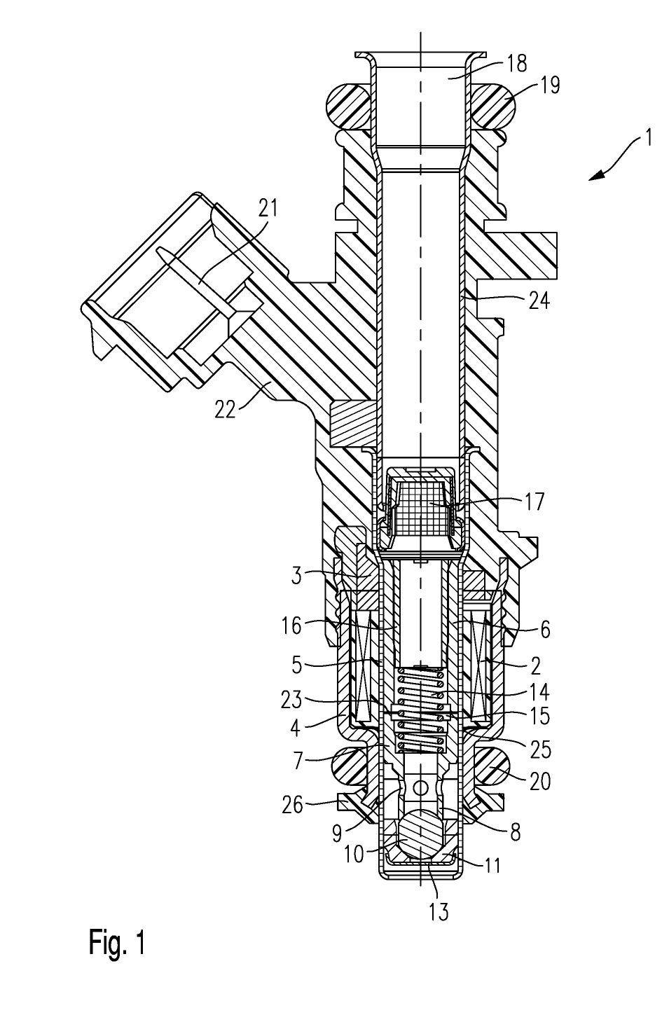

FIG. 1 shows a schematic sectional representation of a longitudinal section through an exemplary embodiment of a fuel injector 1 designed according to the present invention, the fuel injector being suited, in particular, for the injection of fuel into an intake manifold (not shown further) of an internal combustion engine.

Fuel injector 1 includes a solenoid coil 2, which is wound on a coil brace 3. Coil brace 3 is encapsulated in a cup-shaped valve housing 4.

Coil brace 3 is penetrated by a valve sleeve 5 having a tubular design. Downstream from inner pole 6 is an armature 7, which is connected with a valve needle 8.

Valve needle 8 is in operative connection with a valve-closure member 10, which has a spherical form in the exemplary embodiment and forms a sealing seat together with a valve-seat body 11. Downstream from the sealing seat at least one spray-discharge orifice 13 is formed from which the fuel is injected into the intake manifold (not shown further).

In the rest state of fuel injector 1, armature 7 is acted upon by a restoring spring 14 with such a force that fuel injector 1 is held closed by the contact pressure of valve-closure member 10 on valve-seat body 11. Restoring spring 14 is situated in a recess 15 of armature 7 or inner pole 6 and prestressed by an adjusting sleeve 16. On the inflow side of adjusting sleeve 16, a cup-shaped filter element 17 is preferably pressed into valve sleeve 5. The fuel, which is conveyed via a central fuel supply 18, traverses fuel injector 1 through an intake pipe 24, recess 15, and flows to valve-seat body 11 and to spray-discharge orifice 13.

For the purpose of installation on a fuel-distributor line (not shown further), fuel injector 1 is provided with a seal 19 in the region of central fuel supply 18. An additional seal 20 seals the connection (not shown further) between fuel injector 1 and the intake manifold. The intake manifold is not shown further here since it is unimportant for the essence of the present invention. Solenoid coil 2 is energized via a line by an electric current, which may be supplied via an electrical plug contact 21. Plug contact 21 is enclosed by a plastic extrusion coating 22, which may be sprayed onto valve sleeve 5 or intake pipe 24.

If an electric current is supplied to solenoid coil 2 via an electrical line (not shown further), a magnetic field will be generated that, if sufficiently strong, pulls armature 7 into solenoid coil 2, counter to the force of restoring spring 14 and counter to the flow direction of the fuel. This closes a working gap 23 formed between armature 7 and inner pole 6. The movement of armature 7 also carries along in the lift direction valve needle 8, which is integrally joined to armature 7, so that valve-closure member 10 lifts off from valve-seat body 11 and fuel is spray-discharged via spray-discharge orifice 13.

Fuel injector 1 is closed as soon as the electric current energizing solenoid coil 2 is turned off and the magnetic field has decayed to the point where restoring spring 14 presses armature 7 away from inner pole 6, which causes valve needle 8 to move in the discharge direction and valve-closure member 10 to come to rest on valve-seat body 11.

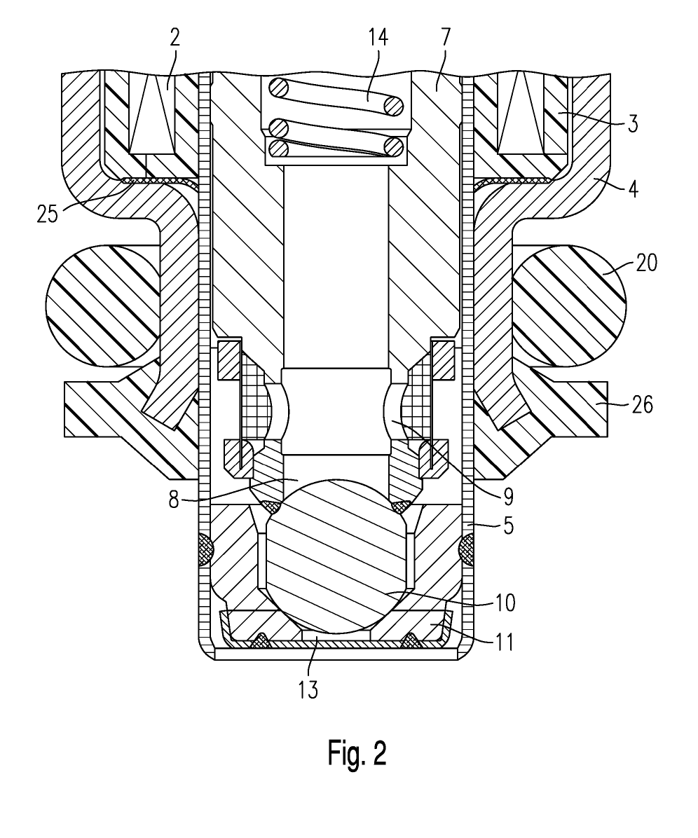

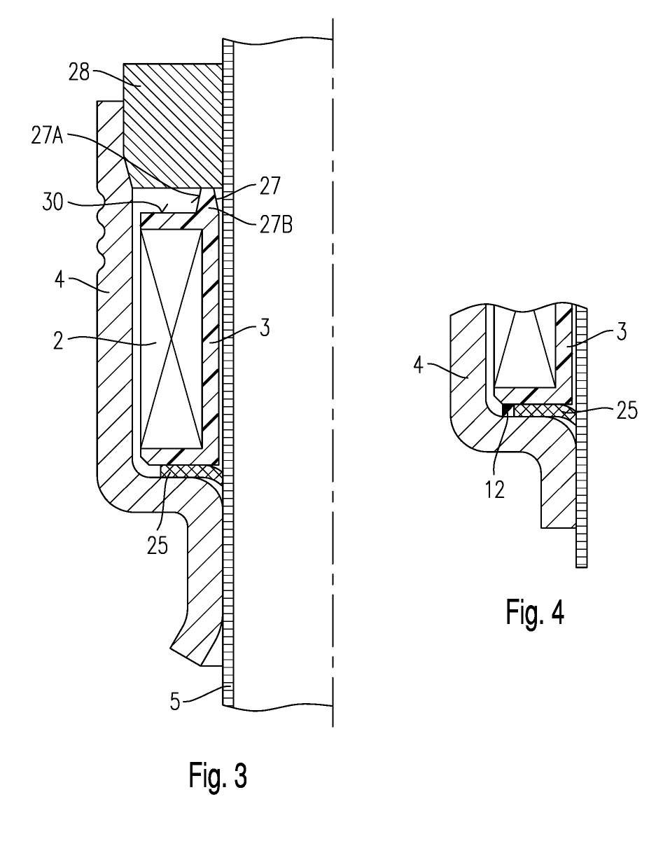

Valve sleeve 5 has a tubular design. According to the present invention, a disk 25 made of an elastomeric material, e.g., a rubber disk 25, is provided between valve housing 4 and valve sleeve 5, disk 25 constituting reliable sealing of valve sleeve 5, an inner radius of disk 25 being smaller than a radius of valve sleeve 5. The inner radius of disk 25 is dimensioned such that sealing of valve sleeve 5 is accomplished. This is shown in the drawings of FIG. 1 to FIG. 4. Moreover, coil brace 3 has at least one projection 27 on an end face 30 facing a top 28 of the coil chamber, e.g., at its inner diameter, the projection being shown in FIG. 3. During installation, axial forces are transmitted from top 28 to rubber disk 25 via end face 30 facing top 28 and via solenoid coil 2/coil brace 3. Rubber disk 25 may be installed either as loose component or, for instance, be fixedly installed on coil brace 3 by cementing.

FIG. 4 shows a coil brace having at its downstream end a radially peripheral collar 12, which is situated circumferentially on the lower end face of coil brace 3, radially outside of rubber disk 25, and which rests against the shoulder of valve housing 4 in a clamped state of rubber disk 25. As an alternative to a circumferential collar, it is also possible to provide a plurality of nubs on the lower end of coil brace 3 in a radially symmetrical manner.

The projection may be present in the form of a partial ring 27A, as shown in FIG. 3, the dimensions of its cross section 27B being small compared to the radial extension of end face 30 facing top 28. Both the height and cross section 27B of projection 27 are dimensioned such that solenoid coil 2 is pressed onto rubber disk 25 regardless of the tolerances of the individual components; the tolerances are compensated for by selective deformation of projection 27. It is also possible to place a plurality of projections 27 across the circumference of coil brace 3.

An axial, play-free initial stress is imparted to solenoid coil 2, it being ensured that the hydraulic pressure brought about by the elastic mass during plug-connection extrusion coating 22 will not cause any additional axial displacement of solenoid coil 2.

The present invention is not limited to the illustrated exemplary embodiments. In particular, any combination of the individual features is possible.

1-17. (canceled)

18. A fuel injector, comprising:
a valve housing;
a solenoid coil;
a restoring spring;
an armature, wherein the armature is acted upon by the restoring spring, and wherein the armature cooperates with the solenoid coil;
a valve needle, wherein valve needle and the armature together form an axially displaceable valve part;
a sealing seat formed by a valve-closure member and a valve-seat body, wherein the valve closure member is provided on the valve needle; and
a disk made of an elastomeric material affixed between the solenoid coil and the valve housing.

19. The fuel injector as recited in claim 18, wherein the disk is axially fixed in place between the solenoid coil and the valve housing by a clamping effect.

20. The fuel injector as recited in claim 19, further comprising:
a valve sleeve, wherein an inner radius of the disk is smaller than a radius of the valve sleeve.

21. The fuel injector as recited in claim 20, wherein the inner radius of the disk is dimensioned to provide sealing of the valve sleeve.

22. The fuel injector as recited in claim 18, wherein the disk is affixed on a coil brace of the solenoid coil.

23. The fuel injector as recited in claim 22, wherein the disk is bonded to a coil brace of the solenoid coil.

24. The fuel injector as recited in claim 22, wherein the disk is made of a fuel-resistant elastomer.

25. The fuel injector as recited in claim 22, wherein the coil brace has at least one projection on a top end face.

26. The fuel injector as recited in claim 25, wherein the projection has a form of at least one partial ring on the top end face of the coil brace.

27. The fuel injector as recited in claim 26, wherein the projection has a form of at least two partial rings on the top end face of the coil brace.

28. The fuel injector as recited in claim 27, wherein each partial ring located on the top end face of the coil brace is part of a circle.

29. The fuel injector as recited in claim 25, wherein a cross section of the at least one projection has one of a triangular shape and a trapezoidal shape.

30. The fuel injector as recited in claim 25, wherein a cross section of the at least one projection is part of a circle.

31. The fuel injector as recited in claim 30, wherein a height of the cross section of the at least one projection is less than a radial extension of the top end face.

32. The fuel injector as recited in claim 18, wherein the solenoid coil is fixed in place between the coil brace and the valve housing with axial pre-stressing.

33. The fuel injector as recited in claim 32, wherein the solenoid coil is fixed in place between the coil brace and the valve housing in such a manner that the solenoid coil does not exhibit any relative movement.

34. The fuel injector as recited in claim 18, wherein the coil brace has one of a collar and a plurality of nubs on a bottom end face, and wherein the one of the collar and the plurality of nubs surrounds the disk circumferentially.
